(19) United States
(12) Patent Application Publication
(10) Pub. No.: US 2004/0138924 A1
(43) Pub. Date: Jul. 15, 2004

(54) System and method for intake of a patient in a hospital emergency room

(76) Inventor: Gorsev Pristine, Toronto (CA)

Correspondence Address: TORYS LLP, 79 WELLINGTON ST. WEST, SUITE 3000, TORONTO, ON, M5K 1N2, CA

(21) Appl. No.: 10/733,345

(22) Filed: Dec. 12, 2003

Related U.S. Application Data
(60) Provisional application No. 60/432,612, filed on Dec. 12, 2002.

(51) Int. Cl. G06F 17/60

(52) U.S. Cl. 705/2

(57) ABSTRACT

The present invention provides a novel system and method for intake of medical patients to emergency rooms at hospitals. An embodiment of the invention includes a kiosk with an audio assisted touch screen that presents a number of intake questions to a patient in their preferred language to automate the repetitive component of the interviews. In response to the questions, the kiosk generates an intake report for presentation to a health care worker such as a doctor or a nurse to create a jump-start for the live interview. In this manner, waiting times at hospital emergency rooms can be used to initiate the patient care, even before they see the health care staff, safely since the application can also streamline the waiting room population and save time for all involved parties including the patients, nurses, the physicians and the health care facility. The application has desktop and web versions. The interview is customizable at every level for the questions, flow and language. The suggested consistent and methodical screening for all system/organs and documentation of the interview's findings helps to reduce physician errors and provides a malpractice shield.

### PRIORITY CLAIM

The present application claims priority from U.S. Provisional Patent Application No. 60/432,612, filed Dec. 12, 2002, the contents of which are incorporated herein by reference.

### FIELD OF THE INVENTION

The present invention relates generally to computerized systems used in the service professions such as medicine, and more particularly relates to patient intake in a hospital emergency room or the like.

### BACKGROUND OF THE INVENTION

As the cost of medical care rises, medical systems are under pressure to provide more care under severe financial constraints. In industrialized countries, these pressures are expected to increase as the baby-boomer population ages. A stretched system means that there can be little room for any increased demand in the system. It is believed that the Severe Acute Respiratory Syndrome (“SARS”) crisis that hit Hong Kong, Toronto and other centres around the world in 2002 pushed various medical systems close to their breaking point.

Even absent a crisis such as SARS, patients are experiencing increasing waits before they receive medical attention. In the medical system it is common for patients to wait until a physician or other health care provider becomes available for a consultation. In order to reduce the time needed for the consultation, an intake worker, often a nurse or intern, will ask the patient a series of routine questions and make a written record of the patient's answers The intake process can also help to prioritize patients who may need more immediate attention than others—for example, a heart attack patient will need more immediate attention than a patient with a sprained ankle.

However, even with the current intake process, patients are still experiencing long waiting periods. This results in frustration for the patient. In centers such as Toronto and New York, there can also be a language barrier as the system attempts to serve populations of diverse backgrounds. One solution is to hire more staff, however, many view this as cost prohibitive.

Automation techniques to help streamline processing of patients are also well known. In particular, various triage type systems are available, that present questionnaires to patients to assist and/or automate diagnosis of the patient's condition. For example, Canadian Patent 2,070,561, (related to U.S. Pat. No. 5,572,421) “Portable Medical Questionnaire Presentation Device” and issued Aug. 12, 2003 provides a hand-held, battery-powered medical questionnaire presentation device. The device has means for displaying questions to the patient, a limited number of keys by which the patient can enter answers, and a memory device for storing the patient's answers. A microcomputer in the device tallies the patient's answers and, on the basis of that information and objective data supplied by a medical staffer, presents an evaluation of aspects of the patient's medical condition or health status. The evaluation may consist of recommendations for tests, an analysis of the patient's general medical condition, an analysis of the patient's surgical risk, an analysis of the patient's functional health status, recommendations for counseling the patient, recommendations for health-related lifestyle improvements, or any other conclusions which may be inferred from the patient's responses. Also of note is that Canadian Patent 2,070,561 contemplates the ability to provide the questionnaire in more than one language. Overall, however, Canadian Patent 2,070,561 is directed to conditions where portability is required, such as for use at bedside by a bedridden patient, or by ambulance technicians or paramedics, and thus the device in Canadian Patent 2,070,561 is not directed to patient intake in an emergency room.

Likewise, U.S. Pat. No. 6,383,135, “System and Method for Providing Self-Screening of Patient Symptoms”, is a triage type system that presents an automated questionnaire in both pictorial and written format to the patient. U.S. Pat. No. 6,383,135 discloses a medical self-screening system that provides for software that displays an image of the body containing selectable regions that may be affected by patient symptoms and that may be selected by the patient. The software then generates an enlarged and more detailed view of the affected area, and the patient can then again select the more specific region of the affected area, The software then displays screens that permit the patient to compare and select the groups of symptoms they are experiencing. The software then displays the appropriate course of action to the patient, which can consist of appropriate tests, referrals, or diagnostic possibilities. U.S. Pat. No 6,383,135 is directed to a medical self-screening system and method that allows patients to evaluate their symptoms and to determine what the next course of action should be. Although the system may direct the patient to an emergency room, it is not directed to meeting the requirements of a patient intake upon arrival at the emergency room.

The prior art includes a number of other automated questionnaire type devices, that are intended either to assist in the triage process, or to be used by patient's at home for self-diagnosis. U.S. Patent Application Publication 2002035486, “Computerized clinical questionnaire with dynamically presented questions”, is another example of such as device. U.S. Patent Application Publication 2002035486 includes a clinical questionnaire system that presents medical questions to a subject and determines additional questions to present based on the subject's response to previous questions. Positive responses to primary questions trigger presentation of secondary and lower-level questions requesting more specific information from the subject. Deeper-level questions follow a medical pathway correlated with a known medical condition and can prompt presentation of clinical warnings. U.S. Patent Application Publication 2002035486 stresses the advantage that, since the questionnaire is patient-centered, it is free from the medical bias inherent in a physician's administration of a questionnaire and orientation as to what constitutes true disease. U.S. Patent Application Publication 2002035486 further stresses that, by only presenting relevant questions, the questionnaire decreases the time burden on the subject. Thus, U.S. Patent Application Publication 2002035486 includes a questionnaire that again is primarily directed to diagnosis, but is not tailored to the specific needs of patient intake in an emergency room.

U.S. Patent Application Publication US2002194031, “Method for acquiring and evaluating data during the admission of a patient for operation”, also includes an automated questionnaire, this time tailored for presentation to a surgeon. U.S. Patent Application Publication US2002194031 discloses a method for the acquisition and evaluation of data during the admission of an operation patient, to thereby enable the doctor to justify a decision when classifying the operation of patient as being in a particular risk group. The patient admission inquiries are made automatically using software, via an interactive data acquisition unit. A risk evaluation is provided throughout the data acquisition process, based on the current status of the data. During the data acquisition process, a list of still urgently required entries is provided with each risk evaluation and as yet unanswered questions are acknowledged as such in order to register the fulfillment of the duty of care in recording the data. Again, the automated questionnaire provided in U.S. Patent Application Publication US2002194031 is not directed to reducing waiting times in emergency rooms, but is tailored to identifying risks to surgeons prior to performing surgery.

Similarly, U.S. Patent Application Publication US20020081558, “Computer-Automated Implementation of User-Definable Decision Rules for Medical Diagnostic or Screening Interpretations”, relates to a method of utilizing software where a physician manipulates the software so that a technician can diagnose a patient in the absence of the physician. The software allows a physician to tailor the processing of test data by manipulating rules in a decision tree so that a value can be assigned to certain test criteria, which allows for comparison with actual test data values. A nonprofessional can then subject digital test results to the decision tree tailored by the physician, thus providing the patient with an analysis based on professional judgment, in the absence of a professional. U.S. Patent Application Publication US20020081558 is directed to increasing the efficient use of physician and patient time involved in diagnosis, but does not address patient intake issues in the emergency room of a medical facility.

A number of other automated questionnaire disclosures can also be found in the prior art. U.S. Pat. No. 3,566,370 provides a device for the automatic history-taking of a patient by presenting a number of slides that pose questions to which a patient can respond by pushing one of a number of buttons associated with a range of responses. By the same token, U.S. Pat. No. 4,130,881, “System and technique for automated medical history taking” discloses an automated medical history taking system and technique where selected branch paths through a questionnaire are provided in accordance with stated patient complaints and wherein medically related questions are offered to the patient. What is particularly stressed in U.S. Pat. No. 4,130,881 is that questions are presented to a patient if medically related to a present area of inquiry, even though the patient may not have actually selected that series of questions. The example is given that, even as patient is questioned only with respect to complaints involving the head and neck, if the patient indicates that he is a heavy smoker, then the patient is provided further questions from the lung section, although this anatomical region was not specified for questioning by the patient. Thus, U.S. Pat. Nos. 3,566,370 and 4,130,881 are directed to assisting in automated patient diagnosis, rather than to managing and streamlining intake of a patient in a medical facility.

It is also known to manage workflow through a hospital through automation. U.S. Pat. No. 5,065,315, “System And Method For Scheduling And Reporting Patient Related Services Including Prioritizing Services”, discloses a computerized hospital system that includes a terminal in all departments of the hospital for entering information pertinent to a patient's stay in the hospital. The initial information entered, as a part of the admitting procedure, includes the patient's history and admitting physician's physical examination results. It additionally includes the physician's orders for tests or hospital services to be performed. The system prints a history and physical report for the patient's chart and highlights the abnormal findings and complaints. The system additionally schedules all hospital services for the patient, thereby eliminating this responsibility from the nurses and other hospital personnel, and avoids situations where the patient is scheduled to be in two places at the same time. The scheduling system is capable of rescheduling tests or services in cases of emergency. Test results and/or technician's comments are entered into the system through terminals in each department and the results and comments are printed at the nurses' station for inclusion in the patient's chart. Additionally, physician's and nurses' notes and findings are entered into the systems, and printed at the nurses' station for inclusion in the chart. The system finally prints a discharge planning document and a narrative discharge report for the chart, as well as a patient instruction document. The information entered into the system may be used by the billing program to bill the patient for all services and tests performed. Thus, while U.S. Pat. No. 5,065,315 can streamline the patient once they are admitted to the hospital, U.S. Pat. No. 5,065,315 actually utilizes technicians or nurses to ask the questions of the patient and input the data, and accordingly U.S. Pat. No. 5,065,315 still depends on a hospital technician to handle the intake of a patient at the emergency room.

The use of an automated system to manage patient records to facilitate scheduling in a medical facility is disclosed in Canadian Patent Application 2,067,747, “System for Centralized Storage of Patient Related Data Records Including Medical Notes and Test Results and for Scheduling Patient Related Services”. Canadian Patent Application 2,067,747 provides for a computerized system of departmental terminals in a hospital that process information that is pertinent to a patient's stay including a patient's history, test or hospital services to be performed, test results and technicians', nurses', and doctors' notes. The system prints out the patient's history and a patient chart report that highlights abnormal findings and complaints. The system also schedules and prioritizes hospital services that the patient requires. Once the patient is ready to be discharged, the system prints discharge planning documentation for the hospital as well as a patient instruction document. Canadian Patent Application 2,067,747 is, therefore, directed to improving the efficiency and timeliness of the administration of a patient during their stay in a medical facility rather than to improving patient intake in the emergency room of the medical facility.

Similarly, U.S. Pat. No. 5,760,704, “Patient Tracking System for Hospital Emergency Facility”, is directed to an electronic patient tracking system for use in a hospital emergency room. The system includes patient tracking modules, which display the patient's name and complaint, and the names of the attending physician and nurse, and which communicate with each other when a patient is moved to a room associated with a different module. U.S. Pat. No. 5,760,704 also provides for color coded switches that illuminate according to orders for work to be done, or that flash to indicate an alarm condition if an order is not completed. The system allows for data entry and for setting of order indicators, as well as for the performance of those functions by the hospital's host computer system. Although directed to hospital emergency rooms, U.S. Pat. No. 5,760,704 relates to patient tracking and electronic handling and manipulation of patient chart information which, again, depends on hospital staff to deal with emergency room patient intake.

U.S. Patent Application Publication US 20020072911, “System and Method for Interactively Tracking a Patient in a Medical Facility”, also relates to an automated system for patient tracking in a medical facility. U.S. Patent Application Publication US 20020072911 discloses a system for registering and tracking a patient in a treatment area of a medical facility by receiving personal, treatment, and logistical patient data U.S. Patent Application Publication US 20020072911 is directed to the processing and tracking of post-admission patient flow on the basis of diagnostic information, rather than to the initial patient intake in the emergency room of a medical facility.

The prior art also discloses information networks that facilitate the delivery of information to physicians, nurses, pharmacists and patients. U.S. Patent Application Publication 20020188467, “Medical Virtual Resource Network”, relates to a virtual resource network that integrates voice interactive, text interactive and streaming video operative on high speed optical and satellite connections to deliver information. The network provides patient records upon voice command and verifies insurance coverage, searches for proper dosage and alternative drugs, and evaluates their price and availability. The network prepares and sends billing information, tracks patient progress and sends reminders to patients. The network can provide access to a second opinion, to universities, and to medical journals and treatises. Thus, U.S. Patent Application Publication 20020188467 relates to the seamless and interactive access and utilization of medical information by physicians in order to improve the delivery and quality of medical services, and to the streamlining of insurance and pharmaceutical procedures, rather than to patient intake in the emergency room of a medical facility.

Similarly, U.S. Patent Application Publication 20020111830, “Method Using a Global Server for Providing Patient Medical Histories to Assist in the Delivery of Emergency Medical Services”, facilitates the delivery of emergency medical services by providing patient information via a wireline or wireless network, the Internet or a wide area network directly to the site of an emergency. U.S. Patent Application Publication 20020111830 is directed to a method for transmitting a patient's medical information directly to a computer at the site of the patient's emergency, either in an emergency room or in a rescue vehicle, or to a personal digital assistant carried by emergency personnel. The method also allows for the provision of insurance information. Thus, the method covered by U.S. Patent Application Publication 20020111830 is directed particularly to providing on-site access to a patient's medical records rather than to facilitating the intake of a patient in the emergency room of a medical facility.

Also in the same vein, U.S. Patent Application Publication 20020046061, “Personal Information System”, relates to a personal information system that stores medical data. U.S. Patent Application Publication 20020046061 allows for a patient to provide medical data to a centralize system such as a healthcare service center, including a hospital or a clinic. U.S. Patent Application Publication 20020046061 also allows for a portable optical disk containing the medical data to be created for the patient to carry. The system provides storage for the data so that a patient can update the medical data via the Internet, and can order an updated optical disk. Thus, U.S. Patent Application Publication 20020046061 relates to a system for the storage and manipulation of patient data in a personal database rather than to increasing the efficiency of patient intake in a medical facility emergency room.

Finally, it is also known to provide remote medical services via two-way communication systems. In this respect, U.S. Pat. No. 6,046,761, “Interactive Communication System for Medical Treatment of Remotely Located Patients”, comprises two inter-communicating stations, one for a patient and one for a physician, with video and audio capability. The patient station is equipped with devices that allow the physician to monitor and measure patient health, with a camera that transmits the patient's identifying documents to the physician, and with a credit card reader for the payment of services. The patient may also make a payment for medical services by using an accepted insurance card or by obtaining an account number from the retailer upon whose premises the station is placed. U.S. Pat. No. 6,046,761 emphasizes the medical diagnosis and treatment of patients in remote locations and does not, therefore, address the intake of patients in the emergency room of a medical facility.

U.S. Pat. No. 6,205,716, “Modular Video Conference Enclosure”, also relates to the provision of remote medical services via two-way communication systems. U.S. Pat. No. 6,205,716 relates to a secure, modular and moveable interactive enclosure that has telecollaborative video conferencing and imaging capabilities and that provides a privileged and confidential environment. The device contemplates the incorporation of equipment for a physician to remotely monitor the physiological aspects of a user's health, as well as for the training and educating of students of the healing arts. U.S. Pat. No. 6,205,716 is directed to an enclosure that provides a secure environment for the remote exchange of sensitive information such as medical data, rather than to the intake of patients in the emergency room of a medical facility.

Overall, it can be seen that the length of time spent to complete the intake of a patient presents a weakness in the medical system.

### SUMMARY OF THE INVENTION

It is an object of the present invention to provide a novel system and method for intake that obviates or mitigates at least one of the above-identified disadvantages of the prior art.

According to an aspect of the invention, there is provided a system for patient intake comprising a computer-based kiosk having an input device such as a keyboard or touch screen and an output device such as a monitor and/or headphones, and a computing unit connected to the input and output devices. The computing unit is operable to receive user responses via the input device and to present a intake questionnaire corresponding to the received user responses. The computing unit is further operable to compile all information gathered during the delivery of the intake questionnaire and prepare a summary of questions asked and a preliminary diagnosis to be verified by a medical pracitioner. The compiled information is then assembled into a report that is printed or otherwise outputted to a doctor or other medical professional. For example, soft copies of the questionnaire can be saved in a storage device connected to the kiosk. For privacy reasons, such retention of soft copies can be made contingent on the patient's consent and made retrievable only by an authorized system administrator. However presented, the report can be used to decrease the time it takes for the doctor to diagnose and/or treat the patient. The computing unit can also be used to prioritize a plurality of patients based on their medical needs and the available medical resources to treat those needs.

The kiosk can use the patient's time that's generally wasted in the waiting room to extract the raw medical data regarding their complaints. Written text questions can be used for literate patients that can walk, talk and wait. For illiterate patients, the questions can be presented using as many pictograms or icons as possible, with audio messages in the patient's prefered language being used to guide the patient through which pictograms to select to provide a particular answer. Translating the questionnaire into as many as possible languages, and translating the report back again to the medical practitioner's native language can ameliorate language barriers.

Headphones can be used to provide hearing assistance as well as privacy and to present the questionnaire, in order to reduce needed cognitive functioning during delivery of the questionnaire. The questionnaire in order can be furthered offered in terms of yes/no answers to further ease the difficulty of talking the questionnaire for the patient.

The present invention provides a novel system and method for intake that can help health care facilities to serve patients more efficiently and within available resources. The facilities can save time and money since they can operate faster and produce more with the same resources. In certain situations where an emergency room is experiencing high demand, it can save time for all involved parties, including the patients, nurses, doctors and health care facility or the corresponding individuals for other types of waiting rooms.

### BRIEF DESCRIPTION OF THE DRAWINGS

The invention will now be described by way of example only, and with reference to the accompanying drawings, in which:

FIG. 1 is a schematic representation of a system for intake in accordance with an embodiment of the invention;

FIG. 2 shows the kiosk of FIG. 1 in greater detail;

FIG. 3 shows a flowchart depicting a method of patient intake in accordance with another embodiment of the invention;

FIG. 4 shows an example screen shot that can be generated on the kiosk of FIG. 2 using the method in FIG. 3;

FIG. 5 shows an example screen shot that can be generated on the kiosk of FIG. 2 using the method in FIG. 3;

FIG. 6 shows an example screen shot that can be generated on the kiosk of FIG. 2 using the method in FIG. 3;

FIG. 7 shows an example screen shot that can be generated on the kiosk of FIG. 2 using the method in FIG. 3;

FIG. 8 shows an example screen shot that can be generated on the kiosk of FIG. 2 using the method in FIG. 3;

FIG. 9 shows an example screen shot that can be generated on the kiosk of FIG. 2 using the method in FIG. 3;

FIG. 10 shows an example screen shot that can be generated on the kiosk of FIG. 2 using the method in FIG. 3 and,

FIG. 11 shows an example of a report that can be generated using the method in FIG. 3.

### DETAILED DESCRIPTION OF THE INVENTION

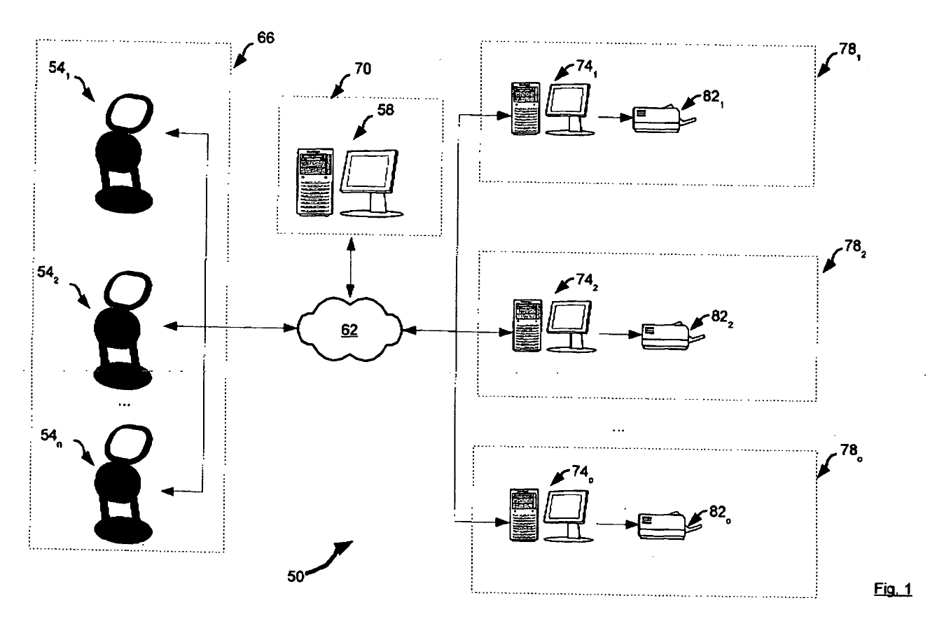

Referring now to FIG. 1, a system for intake is indicated generally at 50. System 50 comprises at least one intake kiosk 54₁, 54₂ . . . 54ₙ (generically referred to herein as kiosks 54) all of which are connected to at least one intake server 58 through a local area network (“LAN”) 62. Each kiosk 54 is generally operable to conduct communications with server 58 over LAN 62. While the present embodiment utilizes a LAN, in other embodiments other networks or combinations of networks can be used. In the present embodiment, system 50 is located in a hospital, wherein kiosks 54 are located in a waiting area 66 of the hospital emergency room, while server 58 is located inside a nursing station 70 of the emergency room.

System 50 also includes a plurality of treatment room clients 74₁, 74₂ . . . 74ₒ that are located in a respective treatment room 78₁, 78₂ . . . 78ₒ of the hospital. Clients 74 are each connected to an output device 82. In a present embodiment, output device 82 is a printer operable to convert an electronic document into paper form. Thus, as patients are admitted to the hospital, they are moved from waiting area 66 to an appropriate one of the treatment rooms 78 wherein a medical practitioner can treat the patient's condition, and/or run diagnostic tests, and/or the like, as appropriate. As will be explained in greater detail below, system 50 is operable to determine an appropriate treatment room 78 for a particular patient, and to schedule a time for that patient to be directed from waiting area 66. Further, system 50 is operable to automatically direct the details of the patient intake to the printer 82 associated with that determined treatment room 78.

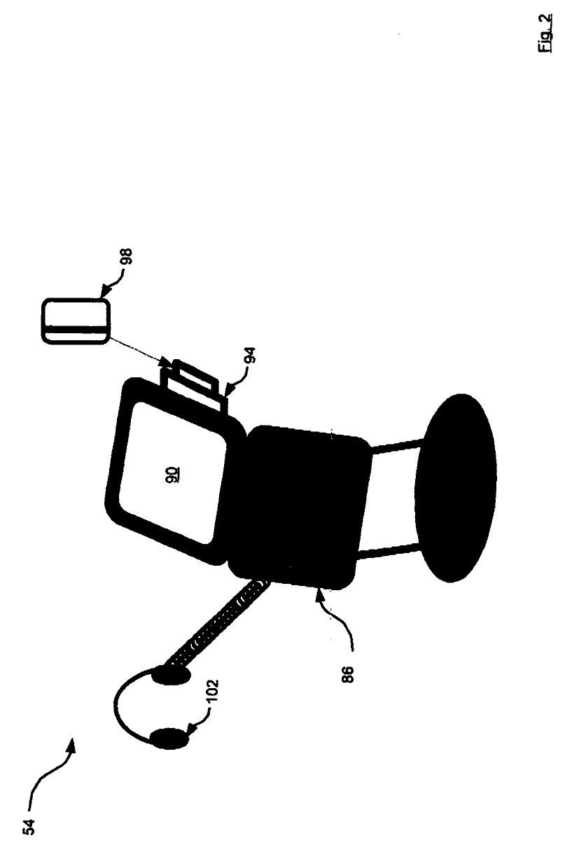

Referring now to FIG. 2, kiosk 54 is shown in greater detail. In a present embodiment, kiosk 54 includes a personal computer (not shown) housed within the chassis 86 of kiosk 54. The personal computer typically includes a tower that includes one or more central processing units, a graphic card, random access memory, storage devices and a network interface to allow the kiosk 54 to communicate over LAN 62. Kiosk 54 includes a touch-screen 90, which is operable to operate as both an input device and an output device. As an input device, touch-screen 90 receives user-input by allowing a patient to depress active portions along the surface of touch-screen 90. As an output device, touch screen 90 is operable to display information on screen 90 in the usual manner. Kiosk 54 additionally includes a magnetic card swipe reader 94 through which a patient can swipe a magnetic stripe card 98. Magnetic stripe card 98 is typically owned by the patient using kiosk 54, and can be a health insurance card, drivers license, credit card or the like. Each kiosk 54 additionally includes a set of headphones 102 that allows a patient to privately listen to audio output generated by kiosk 54. As will be explained in greater detail below, kiosk 54 is generally operable to perform an intake of a patient into the emergency room of the hospital, and to present the results of the intake to the remainder of system 50.

Referring again to FIG. 1, server 58 can be any type of computing device operable to communicate with computing devices connected to LAN 62, such as an Hewlett Packard® personal computer running Linux®, however, any type of computing environment can be used. Server 58 thus includes a tower that includes one or more central processing units, random access memory, storage devices and a network interface to allow the server 58 to receive intake messages from each kiosk 54. Further details about the function of server 58, and by extension the various types of hardware that can be used to implement server 58, will become apparent in the discussion below.

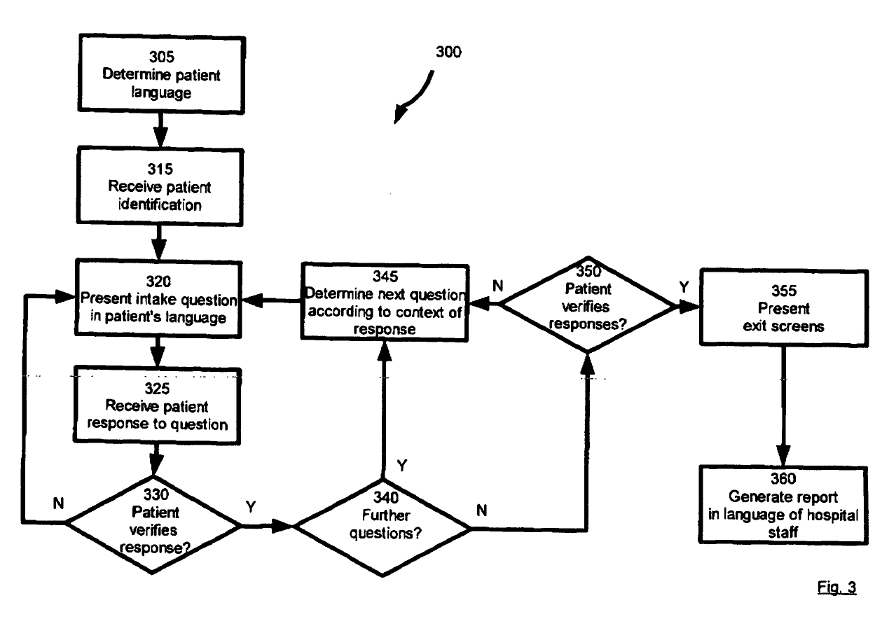

Referring now to FIG. 3, a method for intaking a patient into an emergency room of a hospital is indicated generally at 300. In order to assist in the explanation of the method, it will be assumed that method 300 is operated using system 50. Furthermore, the following discussion of method 300 will lead to further understanding of system 50 and its various components. (However, it is to be understood that system 50 and/or method 300 can be varied, and need not work exactly as discussed herein in conjunction with each other, and that such variations are within the scope of the present invention.)

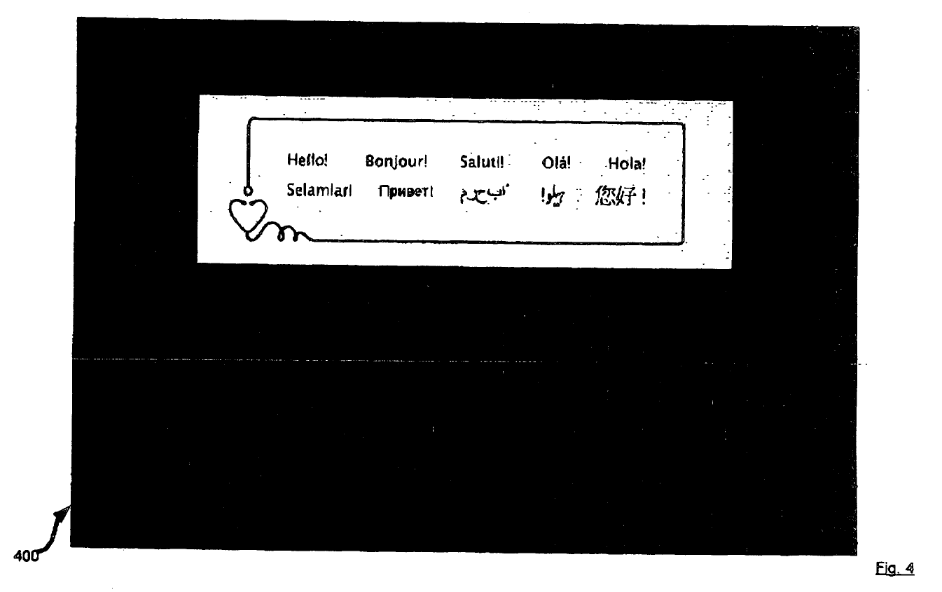

Beginning first at step 305, the preferred language of the patient is determined. This step is performed by kiosk 54, which in its ‘ready’ state displays the welcome screen 400 shown in FIG. 4. A patient arriving at the waiting room 66 of the hospital will approach one of the kiosks 54 and be presented with the welcome screen 400 on touch screen 90. The patient can select from one of the plurality of languages shown on screen 400 by touching the appropriate area of touch screen 90, and kiosk 54 will accordingly determine that the selected language is the preferred language of the patient. In the present example, it is assumed the patient presses “hello” to indicate English as the preferred language.

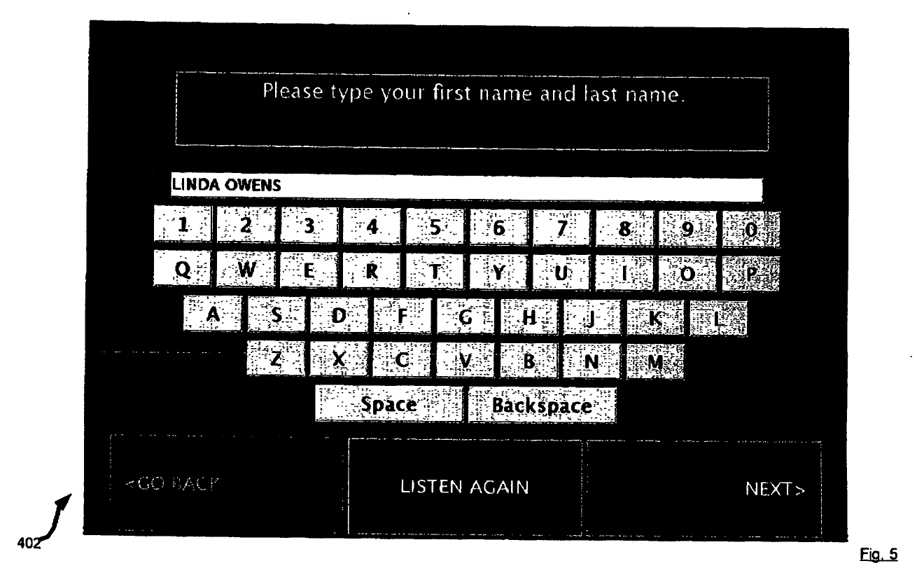

Next, at step 315, the identity of the patient is received. Kiosk 54 will thus present identification screen 402 shown in FIG. 5. Simultaneously, kiosk 54 will play an audio file in the preferred language of the patient through headphones 102 that corresponds to the instructional text in screen 402, namely “Please type your first name and last name.” (While not mentioned in the following discussion, it is to be understood that in the present embodiment such audio files are played for each of the screens displayed on kiosk 54, and in this manner, help alleviate any illiteracy issues for the patient and/or to otherwise enhance the patient's experience with kiosk 54). In this manner, the patient then depresses the “next” area on screen 402 to advance to the next question that is used to determine the identity of the patient. Additional identity questions are typically asked at this point as well, including an address, telephone number, age, gender, hospital insurance information, and social insurance number in order to complete the gathering of the patient's identity at step 315. It should be noted that the questions asked are presented in such a way to comply with relevant privacy laws and or procedures.

As an alternative to using screen 402, (or in addition to using screen 402) kiosk 54 may perform step 315 by requesting that the patient swipe a magnetic stripe card 98 that includes the identity of patient through card reader 94, and through this means establish the identity of the patient. Such a card could be a hospital card, medical insurance card, driver's license, credit card or the like.

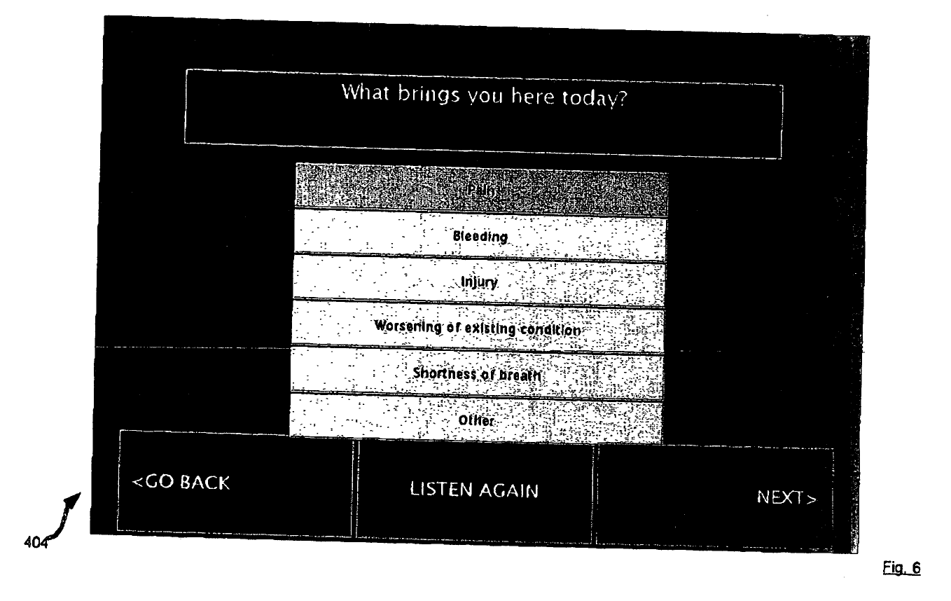

Having received the patient identification at step 315, the method advances to step 320. At step 320 an intake question is presented to the patient in the patient's preferred language. The question is presented in both visual format on screen 90 and in audio format through headphones 102. FIG. 6 shows screen 404 that is presented on screen 90 at step 320, and asks the patient to identify the reason that they are at the emergency room, by presenting the question “What brings you here today?”.

At step 325, the patient response is received. In the example of screen 404 shown in FIG. 6, it is assumed that the patient depresses the button marked “pain”, and shading associated therewith accordingly changes to indicate to the patient that the selection for “pain” has been made.

At step 330, the patient will verify their response made at step 325. It is thus open to the patient at this point to change their selection on screen 104 to something different, in which case at step 330 it will be determined that “no”, the patient has not verified the response and method 300 will return to step 320, at which point screen 90 will present an appropriately updated version of screen 404, and the method will cycle to steps 325 and 330 as previously mentioned. However, if the patient does verify the response, by pressing the “next” button in the bottom right hand corner of screen 404, then method 300 advances to step 340.

(While not shown in method 300, it is also open to the patient to depress the “back” button at this point in the method and return to step 315 to change their identification information).

At step 340, it is determined whether there are further questions to be asked of the patient. Such a determination is based on the preprogrammed questions within kiosk 54, and such questions are based on whether sufficient information exists to provide at least a basic intake report of the patient. Once, at step 320, general questions pertaining to the existence of pain have been ascertained, then in this example at step 340 it would be determined that “yes”, further questions are to be asked and the method advances to step 345.

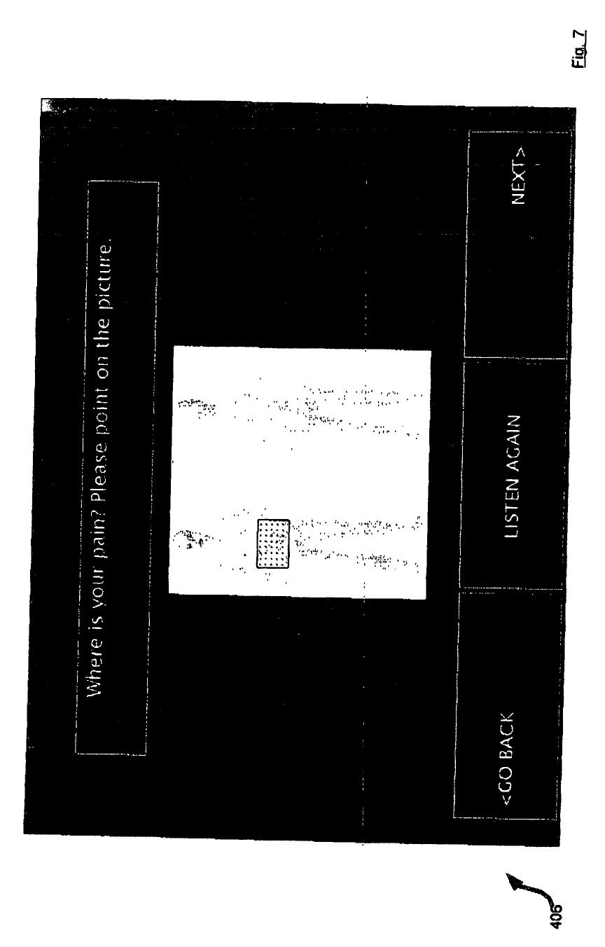

At step 345, the next question to be asked of the patient is determined, such a question being determined according the context of the response received at step 325. Thus, since the patient responded with the answer “pain”, then it is determined that further questions about the patient's pain are to be asked, and the next of those questions is presented on screen 90 as method 300 returns from step 345 to step 320. Continuing with this example, FIG. 7 shows a screen 406 that asks “Where is your pain? Please point to the picture.” Additionally, in screen 406, a pictoral representation of the human body is provided, and the patient can select an area of the body. Method 300 then advances to step 325 again, where the patient selection is received. In the example being given, it is shown on screen 406 that the patient has selected the front abdominal area of the human body.

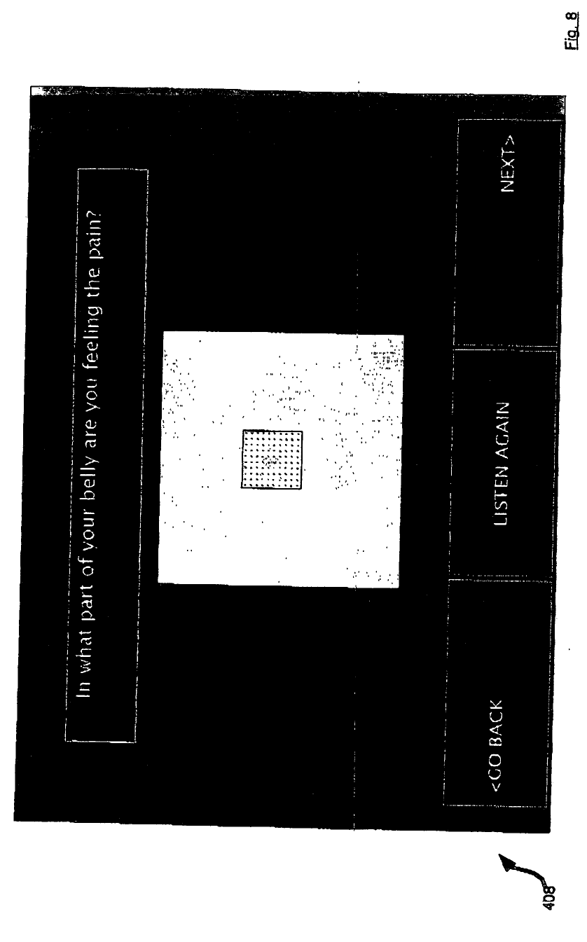

Method 300 then advances to step 330 and step 340 in the manner previously described. For example, FIG. 8, shows screen 408, which is presented at step 320 following the presentation of screen 406 during the previous cycle, and asks the patient to identify more specifically where, in the abdomen, the pain is occurring. Typically, method 300 could cycle through steps 320-345 dozens of times until at step 340 it is determined that “no”, further questions are not needed to complete the intake.

Table I shows a list of questions that give a complete example of a set of intake questions and hypothetical responses for a patient that has indicated abdominal pain that follows with the example being described thus far.

TABLE I
Exemplary Questions

| | Question | Response options | Response (Received at | |
|---|---|---|---|---|
| Question | (Presented at | (Presented at Step | step 325 and verified | Further Questions? |
| Number | Step 320) | 320) | at step 330) | (Step 340) |
| 1 | Hello (in various | Depress “Hello” | Please touch screen to | Yes |
| | languages) | corresponding to | begin. Patient selects | |
| | | patient's preferred | “Hello” according to | |
| | | language. | their preferred | |
| | | | language. | |
| 2 | Please type your | Pictorial | LINDA OWENS | Yes |
| | first name and | representation of a | | |
| | last name. | keyboard. | | |
| 3 | Please type your | Pictorial | 35 | Yes |
| | age. | representation of a | | |
| | | keyboard. | | |
| 4 | Are you male or | Male, Female | Female | Yes |
| | female? | | | |
| 5 | Are you | Pregnant, Not | Pregnant | Yes |
| | pregnant? | Pregnant, Don't know | | |
| 6 | When was your | Less than 4 weeks | Less than 4 weeks ago | Yes |
| | last menstrual | ago, More than 4 | | |
| | period? | weeks ago, | | |
| | | Menstruating now | | |
| 7 | Is this your first | Yes, No | Yes | Yes |
| | visit at this | | | |
| | clinic? | | | |
| 8 | Are you here to | Here to report a new | Here to report a new | Yes |
| | report a new | medical problem | medical problem | |
| | medical problem | Follow up from an | | |
| | or to follow up | earlier visit | | |
| | from an earlier | | | |
| | visit? | | | |
| 9 | Please type the | Pictorial | HEARTBURN | Yes |
| | name of your | representation of a | | |
| | condition(s). | keyboard | | |
| 10 | Have you had | Yes, No | Yes | Yes |
| | any medical | | | |
| | tests lately? | | | |
| 11 | Was it one of | Blood test, | Blood test | Yes |
| | the following | Ultrasound, X-ray, | | |
| | tests? | ECG, CAT Scan, | | |
| | | Endoscopy, MR, | | |
| | | ECHO, Nuclear | | |
| | | imaging test, Other | | |
| 12 | What Brings | Pain, Bleeding, | Pain | Yes |
| | You Here? | Injury, Worsening of | | |
| | | Condition, Shortness | | |
| | | of Breath, Other | | |
| 13 | Where is Your | Pictorial | Abdominal Area | Yes |
| | Pain? Please | representation of | | |
| | point on the | human body with | | |
| | picture. | areas selectable on | | |
| | | touch screen. | | |
| 14 | In what part of | Pictorial | Abdominal Area | Yes |
| | your belly are | representation of | | |
| | you feeling the | human abdomen with | | |
| | pain? | middle of abdomen | | |
| | | selected on touch | | |
| | | screen. | | |
| 15 | Does your pain | Yes, No | No | Yes |
| | go (radiate) | | | |
| | anywhere? | | | |
| 16 | Is this the first | Yes, Not first time | Yes | Yes |
| | time you're | | | |
| | having this | | | |
| | pain? | | | |
| 17 | Did your pain | Yes, No | Yes | Yes |
| | start suddenly? | | | |
| 18 | How old is your | Less than 4 fours, | Less than four hours | Yes |
| | pain? | Between 4 and 24 | | |
| | | hours, Longer than 24 | | |
| | | hours | | |
| 19 | If you gave it a | Less than 5, More | Less than 5 | Yes |
| | score between 1 | than 5 | | |
| | and 10, how bad | | | |
| | is your pain? | | | |
| 20 | Is your pain | Yes, No | Yes | Yes |
| | increasing? | | | |
| 21 | Is your pain | Pain is always, there | Pain is always there | Yes |
| | always there or | Pain comes and goes | | |
| | does it come and | away | | |
| | go away? | | | |
| 22 | Is your pain | Sharp, Dull | Sharp | Yes |
| | sharp or dull? | | | |
| 23 | Do you | Yes, No | Yes | Yes |
| | remember what | | | |
| | you were doing | | | |
| | when it started? | | | |
| 24 | What brings | During rest, During | During rest | Yes |
| | your pain on? | exercise | | |
| | Does it come | | | |
| | during rest or | | | |
| | exercise? | | | |
| 25 | Is your pain | Yes, No | Yes | Yes |
| | related to | | | |
| | eating? | | | |
| 26 | Do you have | Yes, No | Yes | Yes |
| | back pain now? | | | |
| 27 | Do you have | Yes, No | Yes | Yes |
| | high blood | | | |
| | pressure? | | | |
| 28 | Are you | Yes, No | Yes | Yes |
| | coughing? | | | |
| 29 | Do you have a | Yes, No | Yes | Yes |
| | sore throat? | | | |
| 30 | Do your legs | Yes, No | Yes | Yes |
| | become painful | | | |
| | when walking? | | | |
| 31 | How far can you | Less than 2 blocks, | Less than 2 blocks | Yes |
| | walk? | More than 2 blocks | | |
| 32 | Are your ankles | Yes, No | Yes | Yes |
| | swelling? | | | |
| 33 | Did you throw up? | Yes, No | Yes | Yes |
| 34 | What did you | Yes, No | Yes | Yes |
| | throw up? Was | | | |
| | it brown and | | | |
| | similar in | | | |
| | appearance to | | | |
| | coffee grounds? | | | |
| 35 | How much did | Less than a full glass, | Less than a full glass | Yes |
| | you throw up? | More than a full glass | | |
| 36 | How long have | Within the last 4 | Within the last 4 | Yes |
| | you been | hours, In the last 24 | hours | |
| | throwing up? | hours, For longer than | | |
| | | 24 hours | | |
| 37 | Have you been | Yes, No | Yes | Yes |
| | losing weight | | | |
| | during the last 3 | | | |
| | months? | | | |
| 38 | How much | Less than 10 pounds, | Less than 10 pounds | Yes |
| | weight have you | More than 10 pounds | | |
| | lost during the | | | |
| | last 3 months? | | | |
| 39 | Are you | Yes, No | Yes | Yes |
| | sweating now? | | | |
| 40 | Do you have a | Yes, No | Yes | Yes |
| | fever? | | | |
| 41 | Does your neck | Yes, No | Yes | Yes |
| | feel stiff? | | | |
| 42 | How has your | Same, Decreased, | Decreased | Yes |
| | appetite been | Increased | | |
| | lately? | | | |
| 43 | Do you drink | Yes, No | Yes | Yes |
| | alcohol? | | | |
| 44 | How many | Less than 3 times, | Less than 3 times | Yes |
| | times per week | Between 5 or 10 | | |
| | do you drink | times, More than 10 | | |
| | alcohol? | times | | |
| 45 | Do you smoke? | Yes, No, Quit | Yes | Yes |
| 46 | How many | Less than 10 | Less than 10 | Yes |
| | cigarettes do | cigarettes a day, More | cigarettes a day | |
| | you smoke per | than 10 cigarettes a | | |
| | day? | day | | |
| 47 | How long have | Less than 10 years, | Less than 10 years | Yes |
| | you been | More than 10 years | | |
| | smoking? | | | |
| 48 | Do you live | Yes, No | Yes | Yes |
| | alone? | | | |
| 49 | What kind of | Physical labor, Office | Physical labor | Yes |
| | work do you do? | work | | |
| 50 | Have you done | Yes, No | Yes | Yes |
| | any traveling lately? | | | |
| 51 | Are you using | Yes, No | Yes | Yes |
| | any over the | | | |
| | counter | | | |
| | medications? | | | |
| 52 | Are you using | Tylenol, Aspirin, | Aspirin | Yes |
| | any of the | Zantac, Antacid, | | |
| | following | Herbal remedies or | | |
| | medications? | vitamins, Stool | | |
| | | softener, Cough | | |
| | | medication, Claritin, | | |
| | | Nicotine replacement, | | |
| | | Other | | |
| 53 | Are you using | Yes, No | No | Yes |
| | any prescribed | | | |
| | medications? | | | |
| 54 | Do you have | Yes, No | Yes | Yes |
| | allergies? | | | |
| 55 | Are you allergic | Penicillin, Pets & | Peanuts | Yes |
| | to any of the | Animals, Dust, Food, | | |
| | following | Grass or trees, Mold | | |
| | agents? | spores, Cockroaches, | | |
| | | Cigarette Smoke, | | |
| | | Ragweed, Peanuts, | | |
| | | Other | | |
| 56 | Do you have | Yes, No | Yes | Yes |
| | diarrhea? | | | |
| 57 | Do you have | Yes, No | Yes | Yes |
| | blood in your | | | |
| | stool? | | | |
| 58 | Did your urine | Yes, No | Yes | Yes |
| | recently turn | | | |
| | dark? | | | |
| 59 | Are your pants | Yes, No | Yes | Yes |
| | getting tighter | | | |
| | around your | | | |
| | waste? | | | |
| 60 | Are you having | Yes, No | Yes | Yes |
| | difficulty | | | |
| | swallowing? | | | |
| 61 | Do you have a | Yes, No | Yes | Yes |
| | duodenal or | | | |
| | gastric ulcer? | | | |
| 62 | Do you have | Yes, No | Yes | Yes |
| | cirrhosis or liver | | | |
| | disease? | | | |
| 63 | Have you had | Yes, No | Yes | Yes |
| | surgery in your | | | |
| | abdomen (belly) | | | |
| | in the past? | | | |
| 64 | When did you | Within the last 1 | Within the last 1 | Yes |
| | have surgery in | month, Longer than a | month | |
| | your abdomen | month ago | | |
| | (belly)? | | | |
| 65 | Do you have a | Yes, No | Yes | Yes |
| | burning | | | |
| | sensation when | | | |
| | passing urine? | | | |
| 66 | Do you have | Yes, No | Yes | Yes |
| | discharge from | | | |
| | your vagina? | | | |
| 67 | Have you been | Yes, No | Yes | Yes |
| | passing urine | | | |
| | more often than | | | |
| | usual? | | | |
| 68 | Have you been | Yes, No | Yes | Yes |
| | urinating a lot | | | |
| | lately? | | | |
| 69 | Are you | Yes, No | Yes | Yes |
| | sexually active? | | | |
| 70 | How has your | Down, Up, Same | Down | Yes |
| | mood been | | | |
| | lately? | | | |
| 71 | How's your | Down, Up Same | Down | Yes |
| | energy level | | | |
| | lately? | | | |
| 72 | How's your | Less, More, Same | Less | Yes |
| | sleep been | | | |
| | lately? | | | |
| 73 | How has your | Poor, Same | Poor | Yes |
| | memory been | | | |
| | lately? | | | |
| 74 | Have you been | Yes, No | Yes | Yes |
| | feeling anxious | | | |
| | lately? | | | |
| 75 | How's your | Withdrawn, Active | Withdrawn | Yes |
| | social life been | | | |
| | lately? Are you | | | |
| | withdrawn or | | | |
| | socially active? | | | |
| 76 | Do you have | Yes, No | Yes | Yes |
| | pain in your | | | |
| | joints? | | | |
| 77 | Do you have | Yes, No | No | Yes |
| | joint swelling? | | | |
| 78 | Have you been | Yes, No | Yes | Yes |
| | drinking a lot of | | | |
| | water lately? | | | |
| 79 | Do you feel cold | Yes, No | Yes | Yes |
| | easily lately? | | | |
| 80 | Do you have eye | Yes, No | Yes | Yes |
| | problems? | | | |
| 81 | Do you have | Yes, No | Yes | Yes |
| | skin changes? | | | |
| 82 | Do you have | Yes, No | Yes | Yes |
| | hair changes? | | | |
| 83 | Have you been | Yes, No | Yes | Yes |
| | having | | | |
| | chemotherapy? | | | |
| 84 | Do you bruise | Yes, No | Yes | Yes |
| | easily? | | | |
| 85 | Do you have | Yes, No | Yes | Yes |
| | nose bleeds? | | | |
| 86 | Do you feel | Yes, No | Yes | Yes |
| | bumps and | | | |
| | lumps in your | | | |
| | body? | | | |
| 87 | Where do you | Pictorial | Upper Torso Area | Yes |
| | feel lumps and | representation of | | |
| | bumps? Please | human body with | | |
| | point on the | areas selectable on | | |
| | screen. | touch screen. | | |
| 88 | Have you ever | Yes, No | Yes | Yes |
| | had a | | | |
| | gynecological | | | |
| | procedure? | | | |
| 89 | Have you ever | Yes, No | Yes | Yes |
| | been diagnosed | | | |
| | with | | | |
| | ovary/cervix or | | | |
| | uterus cancer? | | | |
| 90 | Have you been | Yes, No | Yes | Yes |
| | having | | | |
| | headaches | | | |
| | lately? | | | |
| 91 | Have you had a | Yes, No | No | Yes |
| | spell or | | | |
| | convulsion? | | | |
| 92 | Do you have | Yes, No | No | Yes |
| | weakness in | | | |
| | your hands or | | | |
| | arms? | | | |
| 93 | Do you have | Yes, No | No | Yes |
| | weakness in | | | |
| | your feet or | | | |
| | legs? | | | |
| 94 | Do you feel | Yes, No | No | Yes |
| | numbness | | | |
| | anywhere in | | | |
| | your body? | | | |
| 95 | Do you have | Yes, No | No | Yes |
| | shaking or | | | |
| | tremors? | | | |
| 96 | Do you | Yes, No | Yes | No |
| | sometimes wet | | | |
| | your underwear? | | | |

It is to be understood that Table I is merely an illustrative example and a virtually infinite number of questionnaires and possible responses can be configured into system 50 as desired.

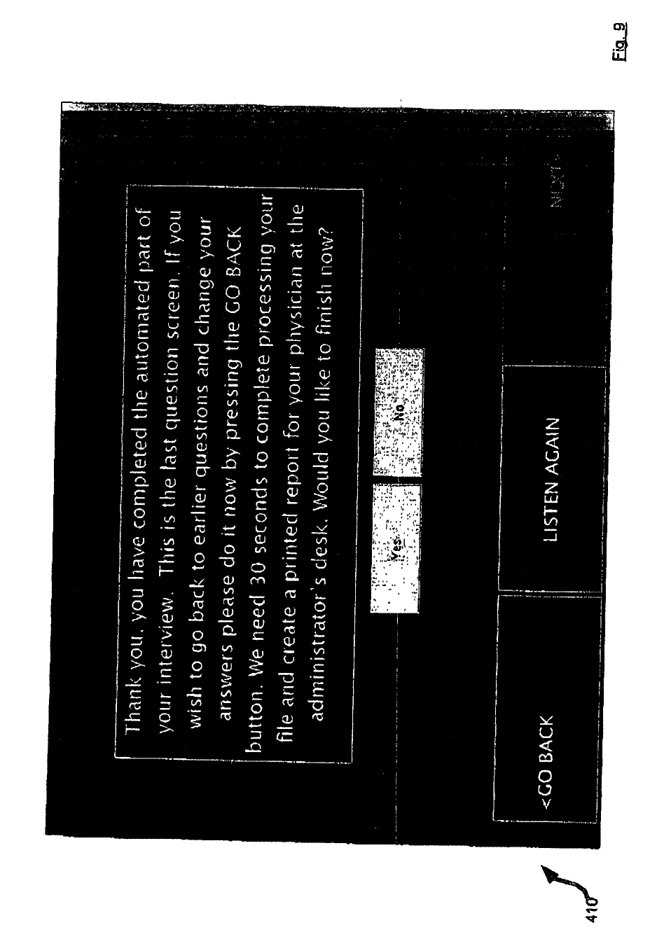

Thus, once the patient completes a sufficient number of questions at step 340, it is determined that “no” further questions need not be asked, then method 300 will advance to step 350. At step 350, screen 410 in FIG. 9 is presented to the patient, which thanks the patient for their responses and offers them the opportunity to decide whether to finish the intake procedure (by pressing “yes”), or to amend the responses (by pressing “no” or “go back”). If the patient presses “no” or “go back” then method 300 moves from step 350 back to step 345, at which point the next question to be presented to the patient is determined as previously described. In this particular situation, the previous question screen may be shown (if “go back” is presses, or if “no” is pressed, then the patient may be given the opportunity to select any number of options, from reanswering certain specific questions to restarting the entire questionnaire).

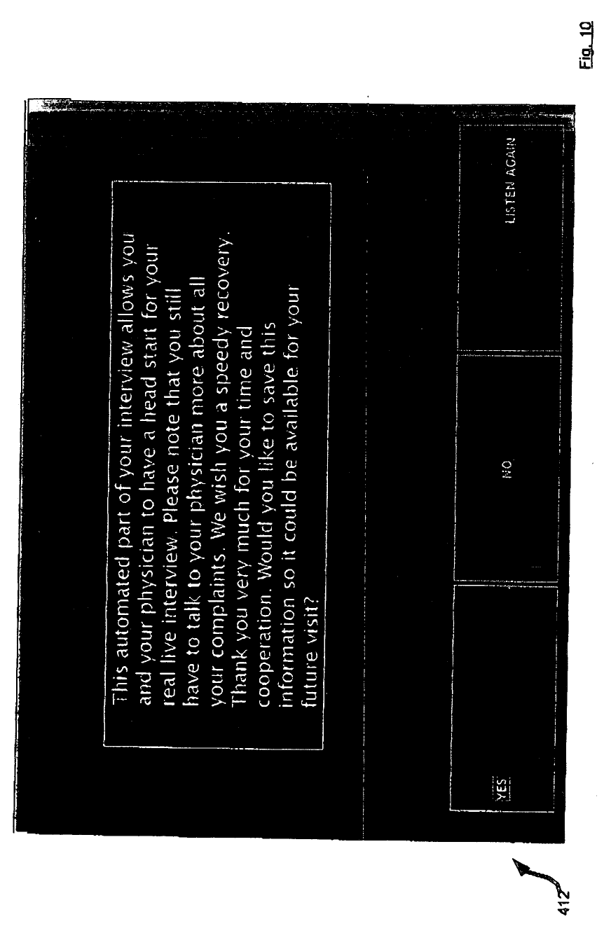

However, if, at step 350, the patient selects “yes”, then method 300 advances to step 355, at which point the exit screens are presented to the patient. Screen 412 of FIG. 10 gives an example of such an exit screen, that gives the patient general instructions about what will happen next. In the present embodiment, screen 412 also asks the patient if they wish to save their questionnaire answers in the event there is a followup visit—this question is posed to respect patient wishes, for example, the patient wishes to protect their privacy and would thereby want to answer “no” to this question.

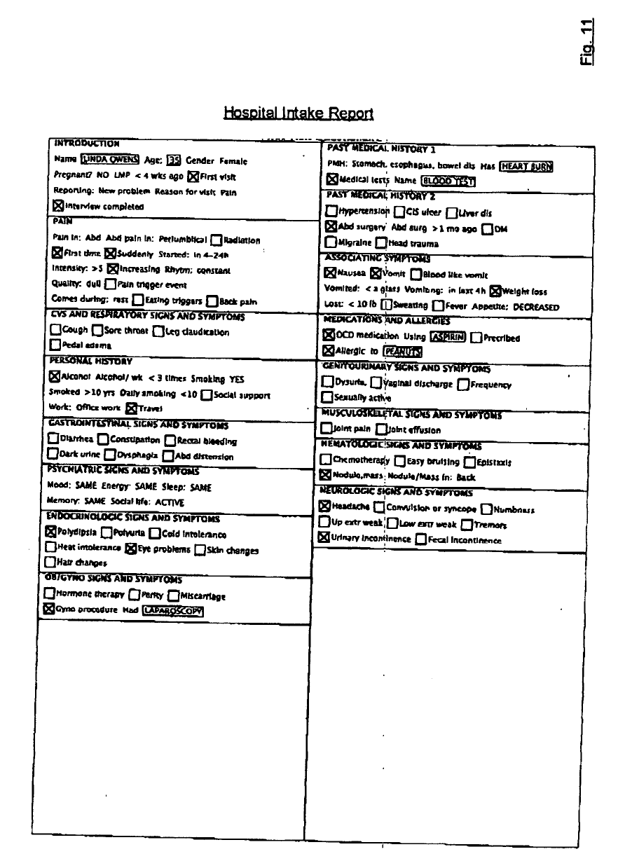

At this point, method 300 advances to step 360 at which point a report summarizing the intake is generated in the language of the hospital staff Referring now to FIG. 11, an example intake report is shown generally at 414 which is based on the exemplary questions and responses provided in Table I. In the present embodiment, it is to be noted that report 414 is directed to an intake report summary for the emergency room of the hospital. In the present embodiment, report 414 is generated by kiosk 54 and sent to server 58. At this point, an operator (i.e. a nurse) of server 58 can manually select an appropriate one of treatment rooms 78 and cause report 414 to be output at the printer 82 corresponding to that selected treatment room 78. Alternatively, this process can be automated, completely or in part, as software executing on server 58 is configured to prioritize various intake reports received from kiosks 54 according to urgency (thereby directing such reports to appropriate treatment rooms 78) according to that urgency, and/or according to the type of condition. Thus, where a condition identified on report 414 is more suitable for the facilities and/or professionals working in one of the treatment rooms, then that report 414 will be delivered to that treatment room 78. Other criteria for selecting a treatment room will now occur to those of skill in the art.

Appendix I attached hereto provides a complete example of a questionnaire that can be used with kiosk 54.

While only specific combinations of the various features and components of the present invention have been discussed herein, it will be parent to those of skill in the art that desired subsets of the disclosed features and components and/or alternative combinations of these features and components can be utilized, as desired. For example, kiosk 54 can be substituted for other types of computing devices, such as, a tablet PC, a personal digital assistant, cell phone, laptop computer, email paging device etc, through which the intake software is activated via a wired or wireless network connection. In this manner, the intake software operating on the computing device can allow the intake procedure to be performed while a patient is at home, office, or other remote location or en route to the hospital, further streamlining the intake process, as the results of the intake process are collected and tabulated by server 70.

As another variation, server 70 can be located at a 911 dispatch centre (or other central dispatch centre), and can be operable to execute the intake software on wired or wireless computing devices of the type previously described. Thus, while a patient is conducting the intake procedures at home or en route to the hospital, server 70 can be dynamically determining availability of certain hospitals to handle the condition being reported by the patient, and direct that patient to a particular hospital that has capacity and/or expertise to handle the patient and the patient's condition.

System 50 can be modified to operate in an application service provider (“ASP”) format, wherein network 62 is the Internet and server 58 hosts the application that performs method 300 (and its variants), and the questions in Appendix I are presented as web-pages on each kiosk 54. As a further variation, where server 58 hosts the application, kiosks 54 (or other suitable computing devices) can actually be located in different waiting rooms of different hospitals or other waiting room environments such as individual doctor's offices. This particular variation can be desirable where the waiting room environment using kiosk 54 does not wish to maintain the hardware and software needed to perform method 300, but instead desires to have the questionnaire engine of system 50 maintained by a third party. By the same token, where server 58 hosts the application that performs method 300, it is also contemplated that the specific questions that are presented on a given kiosk 54 can be remotely configured. In this manner, server 58 can operate an underlying engine that performs method 300, but the specific questions that are posed at step 320, and the linked responses thereto, can be tailored to different ones of the kiosks 54. In other words, a simple user interface can be provided to either server S8 or community service sector since the questions are customizable in terms of text, algorithmic flow, relating printout information, and language.

The above-described embodiments of the invention are intended to be examples of the present invention and alterations and modifications may be effected thereto, by those of skill in the art, without departing from the scope of the invention which is defined solely by the claims appended hereto.

### APPENDIX I

### Exemplary Questionnaire

Section 1: Intro

1(1): Name

1(2): Age

1(3): Gender

if female 1(4): Pregnant?

if pregnant 1(5): How long pregnant

if not pregnant 1(6): LMP

1(7) First visit?

1(8) Reporting new problem or follow up?

if reporting new problem 1(7): Reason for visit

if injured 1(8): Injury location

if injured 1(9): Accident?

In injured 1(10): Assault?

If injured 1(11): Injury when?

If injured 1(12): tetanus history

1(13): Past medical history MH List 1

1(14): Past Medical History MH List 2

if chosen a PMH from list 1(15): Condition name

if chosen other from PMH list 1(16): other condition name

1(17): Medical tests

if had medical tests 1(18): What medical tests

1919): Surgey in last 1 month

if chosen Pain for question 1(7) Section 5: Pain

5(1): Pain location general

if abdominal region selected from image 5(2) Abdominal pain location

5(10): Pain radiates

5(3): Pain first time?

5(4): Pain suddenly?

5(5): Pain duration

5(6): Pain intensity

5(7): Pain increasing?

5(8): Pain constant?

5(9): Pain sharp or dull

5(11): Pain radiation location

5(12): Pain trigger event

5(13): Pain trigger: exercise?

If abdominal pain 5(14): Pain trigger: Eating?

If female and pregnant 5(15): Abdominal cramp

5(16): Back pain

if chosen Bleeding for question 1(7) Section 6: Bleeding

6(1): Bleeding location general

if chosen head in the image for question 6(1) 6(2): Bleeding location head

6(3): Bleeding duration

6(4): Bleeding amount

if chosen mouth or nose for Question 6(2) 6(5): Hemoptisis

if chosen mouth or nose for Question 6(2) 6(6): Hematemesis

if chosen abdomen or bottom Question 6(2)6(7): Hematuria

if chosen abdomen or bottom 6(8): Rectal bleeding

if chosen abdomen or bottom 6(9): Vaginal bleeding

Section 7: Associating Symptoms

7(1) Nausea?

If nausea yes 7(1): Vomiting?

If vomiting yes 7(2): Vomit consistency

If vomiting yes 7(3): Vomit amount

If vomiting yes 7(4): Vomit duration

7(5): Weight loss?

If lost weight 7(6): Weight loss amount

If bleeding or vomited 7(7): Orthostatic hypotension?

7(8): Sweating?

7(9): Fever?

If yes to fever 7(10): Fever duration

If yes to fever 7(11): Fever measured

7(12): Stiff neck?

7(13): Appetite

7(14): Last meal

Section 8: Personal History

8(1): Alcohol?

If yes to alcohol 8(2): How much alcohol?

8(3): Smoking?

If yes to smoking 8(4): Smoking duration

If yes to smoking 8(5): Smoking amount

8(6): Social support

8(7): Work environment

8(8): Travel

Section 9: Medications and Allergy

9(1): OCD?

If yes to OCD 9(2): OCD names

9(3): Prescription?

If yes to prescription 9(4): Prescription names

9(5): Allergy

if yes to allergy 9(6): Allergy names

Section 10: Heart and Lung

10(1): High blood pressure?

If chosen shortness of breath for Question 1(7) 10(2): Heart&Lung disease?

If chosen shortness of breath for Question 1(7) 10(3): What lung disease?

If chosen shortness of breath for Question 1(7) 10(4): Dyspnea history?

If chosen shortness of breath for Question 1(7) 10(5): Nocturnal dyspnea?

If chosen shortness of breath for Question 1(7) 10(6): Orthopnea?

10(7): Cough?

If yes to cough 10(8): Cough duration

If yes to cough 10(9): Sputum?

If yes to sputum 10(10): Sputum color

10(11): Sore throat?

If shortness of breath reported 10(12): Palpitation?

If shortness of breath reported 10(13): Syncope?

10(14): Leg claudication?

If leg claudication yes 10(15): Leg exercise tolerance

10(16): Pretibial edema?

Section 11: GIS

11(1): Diarrhea?

If yes to diarrhea 11(2): Diarrhea duration

If yes to diarrhea 11(3): Diarrhea frequency

If yes to diarrhea 11(4): Mucus in stool

If no to diarrhea 11(5): Constipation?

11(6): Rectal bleeding

11(7): Dark urine?

11(8): Abdominal distention?

11(9): Dysphagia?

11(10); GIS ulcer?

11(11) Cirrhosis or liver dis?

11(12): Abd surgery?

If yes to abdominal surgery 11(13): Abd surgery history

Section 12: GUS

12(1): burning sensation

12(2): Urinary discharge

if female 12(3): Vaginal discharge

if male 12(4): Penile discharge

if male 12(5): Hesitancy

12(6): Frequency

12(7): Nocturia

12(8): Sexually active?

If sexually active 12(9): Condoms?

If sexually active 12(10): Only one sexual partner

If sexually active 12(11): Dyspareunia

12(12): UTI history?

12(13): Urinary tract stone history

Section 14: Psyche

14(1): Mood

14(2): Energy

14(3): Sleep

14(4): memory

14(5): Anxiety?

14(6): Social life

Section 13: Locomotor

13(1): Arthralgia?

If yes to arthralgia 13(2): Mono vs Polyarthralgia

If yes to arthralgia 13(3): Arthralgia location

13(4): Joint effusion?

If yes to arthralgia 13(5): Morning stiffness?

If yes to morning stiffness 13(6): Morning stiffness duration

If yes to morning stiffness 13(7): Morning stiffness and activity

If yes to arthralgia 13(8): Limping?

If yes to limping 13(9): Limping duration

Section 15: Endocrin

15(1): Polydypsia?

If yes to polyuria 15(2): DM?

15(3): Cold intolerance

if no to cold intolerance 15(4): Hot intolerance

15(5): Eye problems

15(6): Skin changes

15(7): Hair changes

Section 16: Hematologic

If bleeding 16(1): Blood disease

If yes to blood disease 16(2): What blood disease

16(3): Chemotherapy

if yes to chemotherapy 16(4): Last chemotherapy

16(5): Easy bruising

16(6): Epistaxis

if yes to epistaxis 16(7): Gum bleeding

16(8): LAP, nodule or mass?

If yes to LAP, nodule or mass 16(9): LAP, nodule or mass location

If female Section 17: OB&Gyno

17(1): OCP?

17(2): Hormone therapy?

17(3): Parity?

If given birth 17(4): Parity number

17(5): Miscarriage

17(6): Gynecologic procedure?

If yes to gynecologic procedure 17(7): What gyno procedure?

17(8): Ovary, cervix or uterus malignancy

Section 18: Neurologic

18(1): Headache

if yes to headache 18(2): Migraine

if yes to headache 18(3): Head injury

18(4): Convulsion?

18(5): Upper extr weakness

18(6): Lower extr weakness

18(7): Numbness

if yes to numbness 18(8): Numbness location

18(9): Slurred speech

18(10): Tremor

18(12): Urinary incontinence

if yes to urinary incontinence 18(13): Fecal incontinence

if yes to 1895) or 18(6) or 18(12) 18(14): Stroke?

Section 20: Finishing

20(1): Edit warning

1. A computing device for location proximal to a waiting area of a hospital emergency room and for intake of a patient in said hospital emergency room comprising a touch-screen operable to receive input by allowing said patient to depress active portions along the surface of said touch-screen, said touch screen further operable to display information to said patient; said computing device further comprising a set of headphones connected to said computing device for presenting audio output to said patient; and wherein said computing device is configured to receive an identification of said patient and a preferred language of said patient, and further operable to present on said touch screen at least one main question and a plurality of dependent questions linked to a response of said main question and each other, said questions presented in said preferred language of said patient, said questions pertaining to an intake procedure of said patient to said hospital, said device further operable to receive responses to each of said of said questions by touch screen input from said patient, said device further operable to generate an intake report based on said responses in a preferred language of a hospital staff member responsible for further processing of said intake of said patient.

2. The device of claim 1 wherein said computing device is attachable to a printing device local to said computing device and wherein said report is generated at said printing device.

3. The device of claim 1 wherein said computing device is connected to an intake server via a network, and wherein said report is delivered to said intake server.

4. The device of claim 3 wherein said intake server is attachable to a printing device local to said intake server and wherein said report is generated at said printing device.

5. The device of claim 3 wherein said intake server is connected to a plurality of treatment room client computing devices via said network, and wherein said treatment room clients include an output device.

6. The device of claim 1 wherein said device is mounted within the housing of a kiosk.

7. The device of claim 1 wherein said device is a stand-alone personal computer.

8. In a computing device for location proximal to a waiting area of a hospital emergency room comprising a touch-screen operable to receive input by allowing depression of active portions along the surface of said touch-screen, said touch screen further operable to display information, a method for intake of a patient in said hospital emergency room comprising the steps of:
receiving input from said touch screen representing a preferred language of said patient;
receiving input from said touch screen representing an identification of said patient;
presenting an intake question to said patient on said touch-screen;
receiving input from said touch screen representing responses to said intake questions;
repeating said presenting and receiving of said responses steps until a desired number of intake question responses have been received; and
generating an intake report in a preferred language of a hospital staff member responsible for further intake of said patient.

9. The method of claim 8 wherein said computing device is attachable to a printing device local to said computing device and wherein said report is generated at said printing device.

10. The method of claim 8 wherein said computing device is connected to an intake server via a network, and wherein said report is delivered to said intake server.

11. The method of claim 10 wherein said intake server is attachable to a printing device local to said intake server and wherein said report is generated at said printing device.

12. The method of claim 10 wherein said intake server is connected to a plurality of treatment root client computing devices via said network, and wherein said treatment room clients include an output device, said intake server operable to determine an available one of said treatment rooms and to direct said report to said treatment room client computing device respective to said available one.

13. The method of claim 8 wherein said computing device is mounted within the housing of a kiosk.

14. The method of claim 8 wherein said computing device is a stand-alone personal computer.

15. A computer readable media for storing programming instructions for use with a computing device for location proximal to a waiting area of a hospital emergency room comprising a touch-screen operable to receive input by allowing depression of active portions along the surface of said touch-screen, said touch screen further operable to display information, and a method for intake of a patient in said hospital emergency room comprising the steps of:
receiving input from said touch screen representing a preferred language of said patient;
receiving input from said touch screen representing an identification of said patient;
presenting an intake question to said patient on said touch-screen;
receiving input from said touch screen representing responses to said intake questions;
repeating said presenting and receipt of said responses steps until a desired number of intake question responses have been received; and
generating an intake report in a preferred language of a hospital staff member responsible for further intake of said patient.

16. A system for intake of a patient in said hospital emergency room comprising at least one computing device associated with a waiting area of a hospital emergency room and a comprising a touch-screen operable to receive input by allowing said patient to depress active portions along the surface of said touch-screen, said touch screen further operable to display information to said patient; said computing device further comprising a set of headphones connected to said computing device for presenting audio output to said patient; and wherein said computing device is configured to receive an identification of said patient and a preferred language of said patient, and further operable to present on said touch screen at least one main question and a plurality of dependent questions linked to a response of said main question and each other, said questions presented in said preferred language of said patient, said questions pertaining to an intake procedure of said patient to said hospital, said computing device further operable to receive responses to each of said questions by touch screen input from said patient, said computing device further operable to generate an intake report based on said responses in a preferred language of a hospital staff member responsible for further processing of said intake of said patient; said system further comprising an intake server for connection to said computing devices and for receiving intake reports generated thereby; said system further comprising a plurality of treatment room clients connected to said intake server, said treatment room clients including an output device operable to present said intake reports; said server operable to direct said intake reports to an appropriate one of said treatment room clients according to a prioritization criteria.

17. The system according to claim 16 wherein said device is a kiosk located in said waiting room.

18. The system according to claim 16 wherein said device is a wireless portable computing device operable to connect with said server via a wireless network such that a patient en route to said hospital can complete at least some of said questions prior to arrival at said hospital.
